(19) United States
(12) Patent Application Publication
(10) Pub. No.: US 2007/0181709 A1
(43) Pub. Date: Aug. 9, 2007

(54) Synthetic jet actuator

(75) Inventor: You-seop Lee, Yongin-si (KR)

Correspondence Address: SUGHRUE MION, PLLC, 2100 PENNSYLVANIA AVENUE, N.W., SUITE 800, WASHINGTON, DC, 20037, US

(73) Assignee: SAMSUNG ELECTRONICS CO., LTD.

(21) Appl. No.: 11/483,615

(22) Filed: Jul. 11, 2006

(30) Foreign Application Priority Data
Feb. 3, 2006 (KR) 10-2006-0010595

(51) Int. Cl. B05C 1/00

(52) U.S. Cl. 239/135; 239/128; 239/566; 347/56; 347/61

(57) ABSTRACT

A synthetic jet actuator includes a housing, a first chamber formed in the housing and filled with a gas, a second chamber formed in the housing to connect to the first chamber and filled with a liquid, an orifice formed to penetrate the housing and which connects the first chamber to the outside, and a heater which generates a bubble by heating the liquid filling the second chamber. As the bubble is generated and terminated inside the liquid in the second chamber by the heater, a volume of the first chamber is periodically changed so that a jet is generated at an outlet of the orifice.

### CROSS-REFERENCE TO RELATED PATENT APPLICATIONS

This application claims the benefit of Korean Patent Application No. 10-2006-0010595, filed on Feb. 3, 2006, in the Korean Intellectual Property Office, the disclosure of which is incorporated herein in its entirety by reference.

### BACKGROUND OF THE INVENTION

1. Field of the Invention

The present invention relates to a synthetic jet actuator and, more particularly, to a synthetic jet actuator which can prevent vibrations and noise and increase a degree of integration.

2. Description of the Related Art

A synthetic jet actuator is a fluidic actuator which generates a momentum source of gas without the transfer of mass. In general, the synthetic jet actuator includes a chamber in which an orifice is arranged at one side of the chamber and a membrane driven by a piezoelectric device is arranged at the other side thereof. In this structure, when the membrane is driven by the piezoelectric device, the volume of the chamber is periodically changed so that vortices are generated around an output of the orifice and the vortices generate a gas jet. In this process, a net mass flux moving through a nozzle becomes zero. The synthetic jet actuator which generates the jet is widely used for a variety of purposes such as the control of heat flow, cooling of electronic equipments, decrease in the drag force of an automobile or airplane, and reduction of noise generated during driving an automobile.

FIG. 1 shows a synthetic jet actuator disclosed in U.S. Patent Ser. No. 6,457,654. Referring to FIG. 1, a housing 11 includes an upper wall 13 and a side wall 12 and a chamber 14 is formed inside the housing 11. An orifice 16 is formed at the upper wall 13 located in the upper portion of the chamber 14. A membrane 18 is provided in the lower portion of the chamber 14 and moves toward the inside and outside of the chamber 14. The membrane 18 is periodically driven by a control system 24 such as a piezoelectric device.

FIGS. 2A and 2B are views showing the operation of the conventional synthetic jet actuator of FIG. 1. FIG. 2A shows the membrane moving toward the inside of the chamber, while FIG. 2B shows the membrane moving toward the outside of the chamber. Referring to FIG. 2A, first, when the membrane 18 is moved toward the inside of the chamber 14 by the control system 24, the volume of the chamber 14 decreases and accordingly the air inside the chamber 14 is ejected outwardly through the orifice 16. The ejected air is separated at a corner portion of the orifice 16 so that vortices 34 are generated.

Next, referring to FIG. 2B, when the membrane 18 is moved toward the outside of the chamber 14 by the control system 24, the volume of the chamber 14 increases and accordingly the air outside the chamber 14 is sucked in through the orifice 16. In this process, the air jet is synthesized by the vortices 34 generated around an outlet of the orifice 16.

However, in the above conventional synthetic jet actuator, when the membrane 18 is driven by the piezoelectric device, noise or vibrations may be generated. Also when the synthetic jet actuator using the piezoelectric device is manufactured in an array, since it is difficult to make a degree of integration over 100 cpi (cells per inch), it is a problem that the degree of integration is low.

### SUMMARY OF THE INVENTION

To address the above and/or other problems, the present invention provides a synthetic jet actuator which generates a jet using the generation and termination of bubbles based on a phase change so that the generation of vibrations and noise is prevented and a degree of integration is improved.

According to an aspect of the present invention, a synthetic jet actuator includes a housing, a first chamber formed in the housing and filled with a gas, a second chamber formed in the housing to connect to the first chamber and filled with a liquid, an orifice formed to penetrate the housing and which connects the first chamber to the outside, and a heater which generates a bubble by heating the liquid filling the second chamber, in which the bubble is generated and terminated inside the liquid in the second chamber by the heater, a volume of the first chamber is periodically changed so that a jet is generated at an outlet of the orifice.

The first chamber and the second chamber are respectively formed in upper and lower portions of the housing. A chamber partition wall to separate the first chamber from the second chamber is provided on an inner wall of the housing and a through-hole to connect the first and second chambers is formed in the chamber partition wall.

The orifice is formed in an upper portion of the first chamber. The heater is provided on a bottom surface of the second chamber.

An electrode which applies current to the heater is formed on the bottom surface of the second chamber. A passivation layer for protecting the heater and the electrode is formed on surfaces of the heater and the electrode.

The synthetic jet actuator further includes a liquid reservoir which connects to the second chamber and supplies the liquid to the second chamber.

A synthetic jet actuator array comprising a plurality of synthetic jet actuators and each of the synthetic jet actuators includes a housing, a first chamber formed in the housing and filled with a gas, a second chamber formed in the housing to connect to the first chamber and filled with a liquid, an orifice formed to penetrate the housing and which connects the first chamber to the outside, and a heater which generates a bubble by heating the liquid filling the second chamber.

### BRIEF DESCRIPTION OF THE DRAWINGS

The above and other features and advantages of the present invention will become more apparent by describing in detail exemplary embodiments thereof with reference to the attached drawings, in which:

FIG. 1 is a view showing the conventional synthetic jet actuator;

FIGS. 2A and 2B are views showing the operation of the conventional synthetic jet actuator of FIG. 1;

FIG. 3 is a view showing a synthetic jet actuator according to an exemplary embodiment of the present invention;

FIGS. 4A and 4B are views showing the operation of the synthetic jet actuator of FIG. 3;

FIGS. 5A and 5B are view showing the results of air jet injection simulation of the synthetic jet actuator according to an exemplary embodiment of the present invention;

FIG. 6 is a graph showing the velocity of air jet measured at a position located 60 μm from the outlet of the orifice in the synthetic jet actuator according to an exemplary embodiment of the present invention; and

FIG. 7 is a view showing an array of a plurality of synthetic jet actuators according to another exemplary embodiment of the present invention.

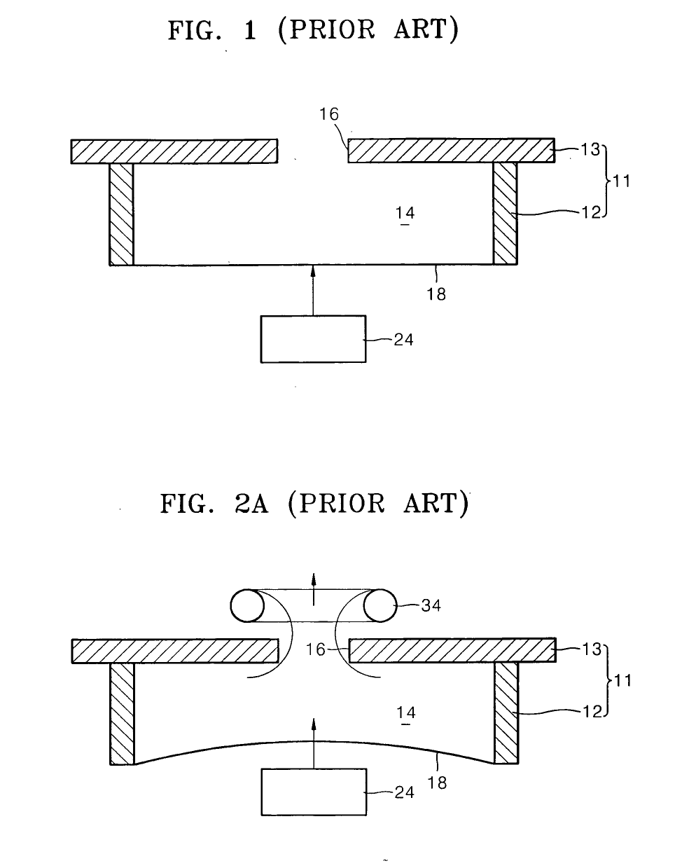

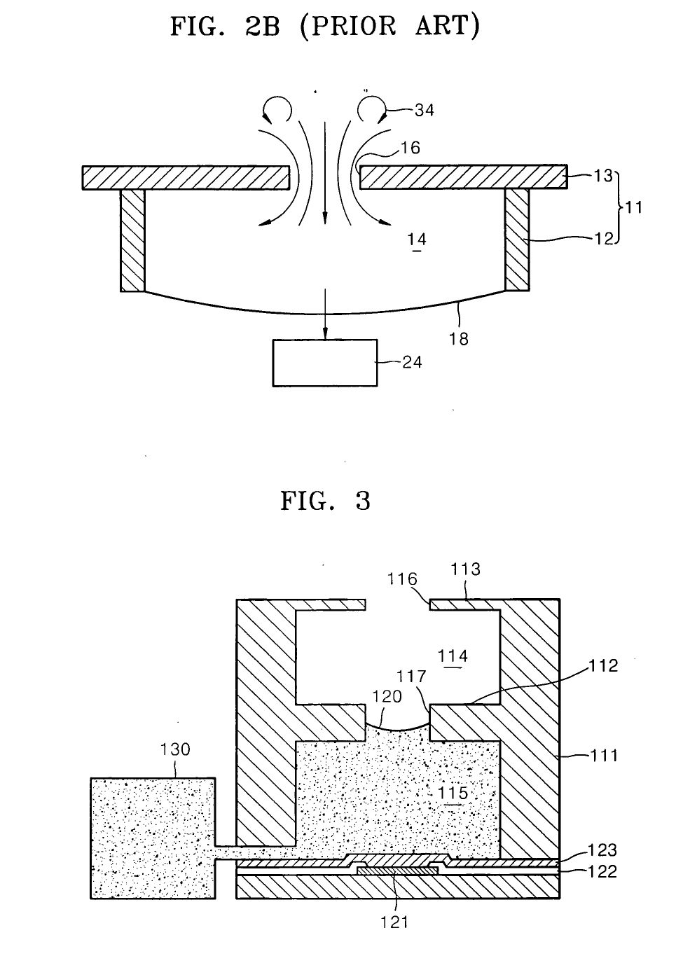

### DETAILED DESCRIPTION OF ILLUSTRATIVE, NON-LIMITING EMBODIMENTS OF THE INVENTION

In the accompanying drawings, like reference numerals indicate like constituent elements. Referring to FIG. 3, a synthetic jet actuator according to an exemplary embodiment of the present invention include's a housing 111 in which a first chamber 114 and a second chamber 115 are connected to each other. The first chamber 114 is formed in the upper portion of the housing 111 while the second chamber 115 is formed in the lower portion thereof. The first chamber 114 is filled with a gas such as, for example, air and the second chamber 115 is filled with a liquid such as, for example, water or oil.

An orifice 116 which connects the first chamber 114 to the outside is formed at the upper wall 113 of the housing 111 located in the upper portion of the first chamber 114 by penetrating the same. A chamber partition wall 112 separating the first chamber 114 from the second chamber 115 is provided on an inner wall of the housing 111. A through-hole 117 connecting the first and second chambers 114 and 115 is formed in the chamber partition wall 112. A meniscus 120 of the liquid filling the second chamber 115 is located inside the through-hole 117.

A heater 121 to heat the liquid in the second chamber 115 to generate bubbles is provided on a bottom surface of the second chamber 115. The heater 121 is made of a resistive heating element such as a tantalum-aluminum alloy, tantalum nitride, titanium nitride, and tungsten silicide. The heater 121 instantly heats the liquid in the second chamber 115 to a predetermined temperature so that, as the liquid is boiled, bubbles are generated and expand. The heating temperature of the heater 121 can be variously controlled according to the type of the liquid filling the second chamber 115. An electrode 122 to periodically apply current to the heater 121 is formed on the bottom surface of the second chamber 115. The electrode 122 may be formed of a material having a high electric conductivity such as aluminum, an aluminum alloy, gold, and silver. A passivation layer 123 can be formed on the surfaces of the heater 121 and the electrode 122. The passivation layer 123 protects the heater 121 and the electrode 122 from the liquid in the second chamber 115.

A liquid reservoir 130 connected to the second chamber 115 can be provided at a side of the housing 111. Since the liquid in the second chamber 115 can be partially consumed due to vaporization, an amount of the liquid corresponding to the amount of the consumed liquid is supplied from the liquid reservoir 130 to the second chamber 115.

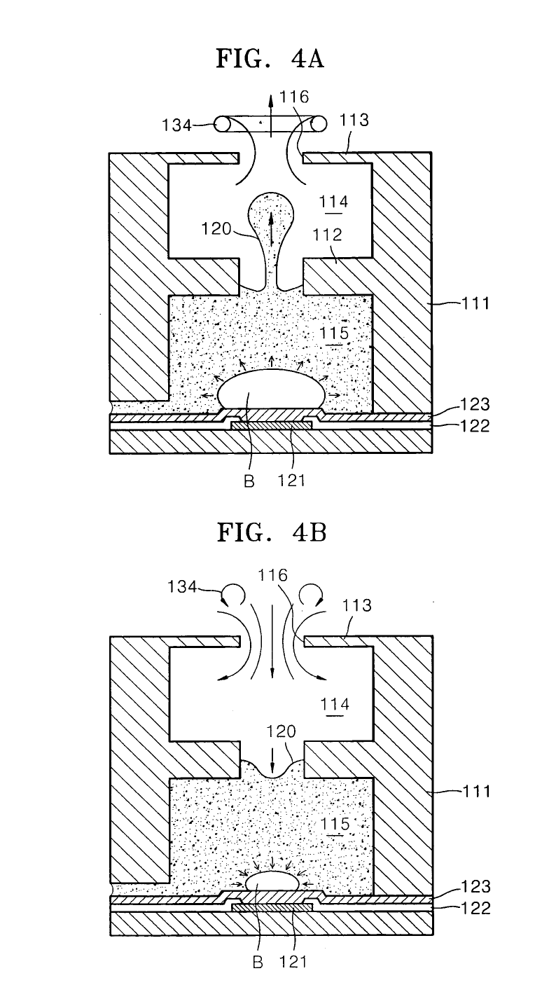

FIGS. 4A and 4B are views showing the operation of the synthetic jet actuator of FIG. 3. Referring to FIG. 4A, when current is applied to the heater 121 through the electrode 122, the heater 121 is heated so that the liquid in the second chamber 15 is heated to a predetermined temperature. The heated liquid is boiled so that a bubble B is generated. The bubble B expands inside the second chamber 115. In this process, the meniscus 120 of the liquid in the second chamber 115 ascends through the through-hole 117 formed in the chamber partition wall 112 by the expansion force of the bubble B and enters the inside of the first chamber 114. Accordingly, the volume of the first chamber 114 is decreased and the gas filling the first chamber 114, for example, air, is ejected toward the outside through the orifice 116. The ejected gas is separated at the corner portion of the orifice 116 to generate vortices 134.

Referring to FIG. 4B, when the current applied to the heater 121 is cut off, the bubble B expanding in the second chamber 115 contracts and then disappears. In this process, the meniscus 120 of the liquid of the second chamber 115 descends along the through-hole 117 formed in the chamber partition wall 112 and comes in the second chamber 115. Accordingly, the volume of the first chamber 114 increases and gas around the outlet of the orifice 116, for example, air, comes into the first chamber 114 through the orifice 116. Thus, the jet of the gas is synthesized by the vortices 134 generated around the outlet of the orifice 116.

As described above, when the bubble B periodically expands and contracts in the second chamber 115 filled with the liquid, the volume of the first chamber 114 filled with the gas is periodically changed so that a jet flow of the gas having a predetermined velocity is periodically generated around the outlet of the orifice 116.

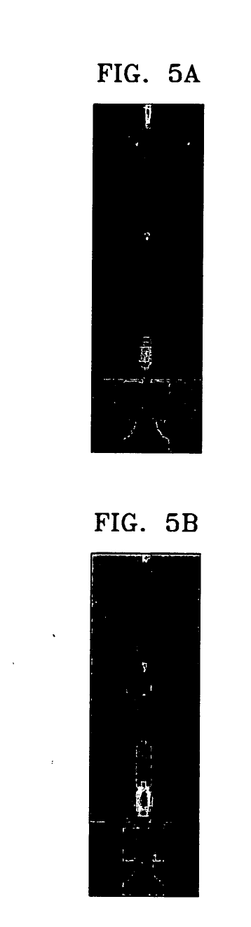

FIGS. 5A and 5B are views showing the results of air jet ejection simulation of the synthetic jet actuator according to an exemplary embodiment of the present invention. In this experiment, air is used as the gas filling the first chamber 114 and water is used as the liquid filling the second chamber 115. FIG. 5A shows the air jet injection around the outlet of the orifice 116 when the bubble B expands in the second chamber 115. FIG. 5B shows the air jet around the outlet of the orifice 116 when the bubble B contracts in the second chamber 115.

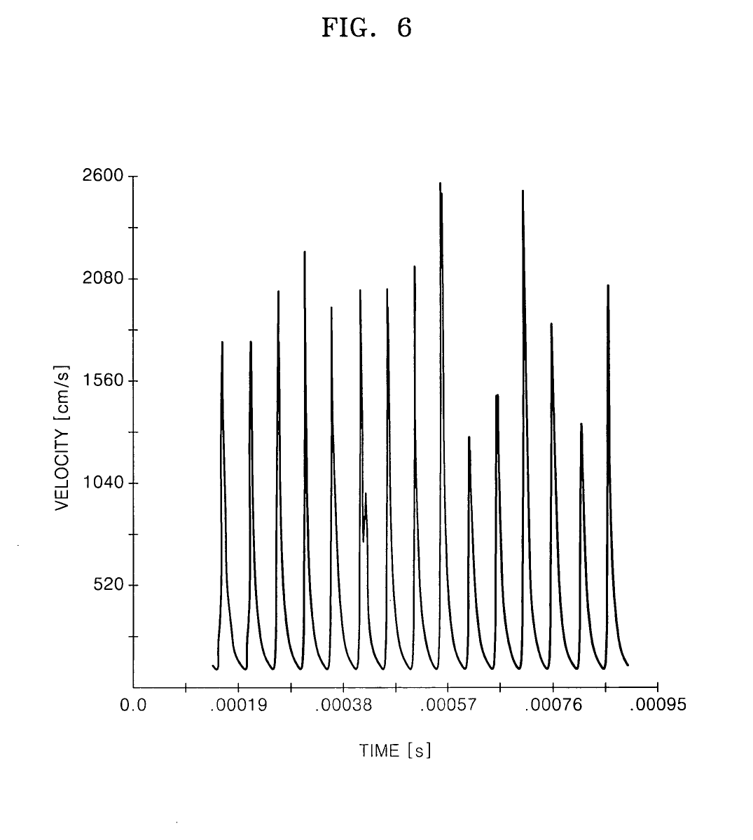

FIG. 6 is a graph showing the velocity of air jet measured at a position located 60 μm away from the outlet of the orifice 116 in the synthetic jet actuator according to an exemplary embodiment of the present invention as the bubble B periodically expands and contracts in the second chamber 115. The diameter of the orifice 116 is 30 μm. Referring to FIG. 6, it can be seen that the velocity of the air jet is about 15-20 m/s at a position located 60 μm away from the outlet of the orifice 116.

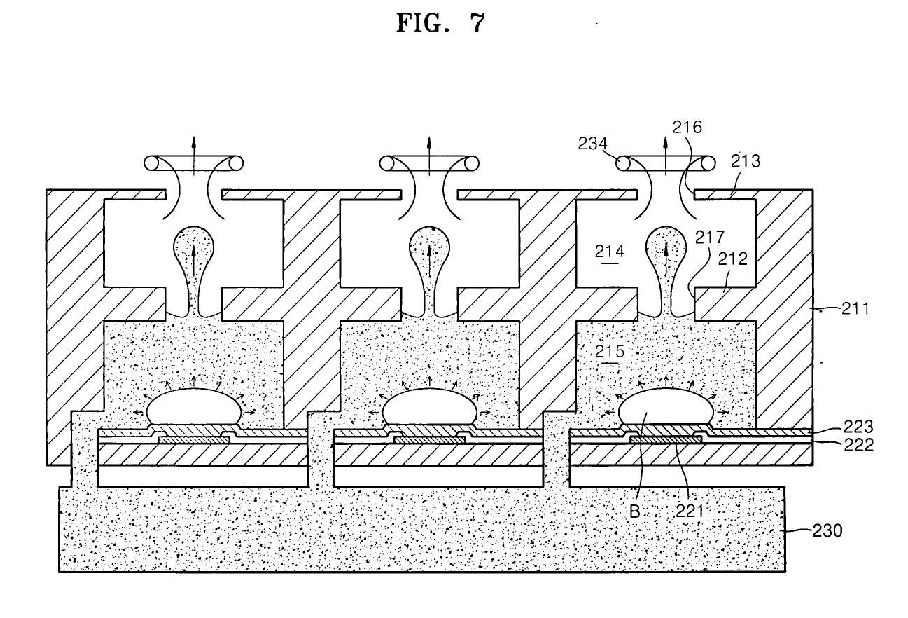

The above-described synthetic jet actuator can be manufactured in an array form as shown in FIG. 7. FIG. 7 is a view showing an array of a plurality of synthetic jet actuators according to another exemplary embodiment of the present invention. Referring to FIG. 7, the synthetic jet actuator array has a structure in which a plurality of synthetic jet actuators are arranged in a predetermined form. In detail, a plurality of first chambers 214 and second chambers 215 connected to one another are formed in a housing 211. The first chambers 214 are filled with a gas such as air, while the second chambers 215 are filled with a liquid such as water or oil. An orifice 216 is formed in the upper portion of each of the first chambers 214 by penetrating the housing 211. A chamber partition wall 212 to separate each of the first chambers 214 from each of the second chambers 215 is provided on an inner wall of the housing 211. A through-hole 217 connecting the first and second chambers 214 and 215 is formed in the chamber partition wall 212.

A heater 221 to heat the liquid in the second chambers 215 and generate the bubbles B and an electrode 222 to apply current to the heater 221 are provided on the bottom surface of each of the second chambers 215. A passivation layer 223 protects the heater 221 and the electrode 222 is formed on the surfaces of the heater 221 and the electrode 222. A liquid reservoir 230 connecting the second chambers 215 can be provided outside the housing 211. The liquid reservoir 230 supplies the liquid, as much as the amount that is consumed due to vaporization of the liquid filling the second chambers 215, to the second chambers 215.

In the above structure, when the bubbles B generated by the heaters 221 in the second chambers 215 periodically expand and contract, the volumes of the first chambers 214 are periodically changed so that a gas jet is periodically generated at an outlet of the orifice 216. FIG. 7 shows a state in which the bubbles B expand in the second chambers 215, in which reference numeral 234 denotes vortices generated around the outlet of the orifice 216. The synthetic jet actuator array can be manufactured using a MEMS (microelectromechanical system). Accordingly, the degree of integration is between several cpi to 600 cpi.

As described above, in the synthetic jet actuator consistent with to the present invention, since jet is generated through the generation and termination of the bubble using a phase change, noise and vibrations can be greatly reduced compared to the conventional synthetic jet actuator using a piezoelectric device. Also, when the synthetic jet actuator consistent with the present invention is manufactured in an array, since a degree of integration can be increased to about 600 cpi, the degree of integration can be greatly increased compared to the conventional synthetic jet actuator using a piezoelectric device.

While this invention has been particularly shown and described with reference to exemplary embodiments thereof, it will be understood by those skilled in the art that various changes in form and details may be made therein without departing from the spirit and scope of the invention as defined by the appended claims.

What is claimed is:

1. A synthetic jet actuator comprising:
a housing;
a first chamber formed in the housing and filled with a gas;
a second chamber formed in the housing to connect to the first chamber and filled with a liquid;
an orifice formed to penetrate the housing and which connects the first chamber to the outside; and
a heater which generates a bubble by heating the liquid filling the second chamber,
wherein, as the bubble is generated and terminated inside the liquid in the second chamber by the heater, a volume of the first chamber is periodically changed so that a jet is generated at an outlet of the orifice.

2. The synthetic jet actuator of claim 1, wherein the first chamber and the second chamber are respectively formed in upper and lower portions of the housing.

3. The synthetic jet actuator of claim 2, wherein a chamber partition wall to separate the first chamber from the second chamber is provided on an inner wall of the housing and a through-hole to connect the first and second chambers is formed in the chamber partition wall.

4. The synthetic jet actuator of claim 2, wherein the orifice is formed in an upper portion of the first chamber.

5. The synthetic jet actuator of claim 2, wherein the heater is provided on a bottom surface of the second chamber.

6. The synthetic jet actuator of claim 5, wherein an electrode which applies current to the heater is formed on the bottom surface of the second chamber.

7. The synthetic jet actuator of claim 6, wherein a passivation layer for protecting the heater and the electrode is formed on surfaces of the heater and the electrode.

8. The synthetic jet actuator of claim 1, further comprising a liquid reservoir which connects to the second chamber and supplies the liquid to the second chamber.

9. A synthetic jet actuator array comprising a plurality of synthetic jet actuators, wherein each of the synthetic jet actuators includes:
a housing;
a first chamber formed in the housing and filled with a gas;
a second chamber formed in the housing to connect to the first chamber and filled with a liquid;
an orifice formed to penetrate the housing and which connects the first chamber to the outside; and
a heater which generates a bubble by heating the liquid filling the second chamber.

10. The synthetic jet actuator array of claim 9, wherein each of the synthetic jet actuators further comprises an electrode to apply current to the heater.

11. The synthetic jet actuator array of claim 10, wherein a passivation layer for protecting the heater and the electrode is formed on surfaces of the heater and the electrode.

12. The synthetic jet actuator array of claim 9, wherein a chamber partition wall to separate the first chamber from the second chamber is provided on an inner wall of the housing and a through-hole to connect the first and second chambers is formed in the chamber partition wall.

13. The synthetic jet actuator array of claim 9, further comprising a liquid reservoir which connects to the second chamber and supplies the liquid to the second chamber.
